(19) United States
(12) Patent Application Publication
(10) Pub. No.: US 2018/0111353 A1
(43) Pub. Date: Apr. 26, 2018

(54) BUFFERED ADHESIVE STRUCTURES FOR WEARABLE PATCHES

(71) Applicant: MC10, Inc., Lexington, MA (US)

(72) Inventors: Gilbert Lee Huppert, Stoneham, MA (US); Xianyan Wang, San Jose, MA (US); Roozbeh Ghaffari, Cambridge, MA (US); Pinghung Wei, Burlingame, CA (US); Ji Hyung Suzy Hong, Somerville, MA (US); Hakan Mutlu, North Chelmsford, MA (US); Brian Murphy, Medford, MA (US); David G. Garlock, Derry, NH (US)

(21) Appl. No.: 15/850,523

(22) Filed: Dec. 21, 2017

Related U.S. Application Data
(63) Continuation-in-part of application No. 15/183,513, filed on Jun. 15, 2016.
(60) Provisional application No. 62/175,785, filed on Jun. 15, 2015.
(60) Provisional application No. 62/437,162, filed on Dec. 21, 2016.

(51) Int. Cl. B32B 7/12; B32B 27/40; B32B 5/02; B32B 5/18; B32B 25/12; B32B 27/30

(52) U.S. Cl. CPC B32B 7/12; B32B 27/40; B32B 5/022; B32B 5/024; B32B 5/18; B32B 2307/702; B32B 27/308; B32B 2556/00; B32B 2535/00; B32B 2262/0253; B32B 25/12

(57) ABSTRACT

The present invention describes multilayered adhesive structures that can be used as adhesives to mount wearable devices onto the skin. The multilayered adhesive structures can comprise a buffer layer sandwiched between two adhesive layers, a first adhesive layer adhering the multilayered adhesive structure to the wearable device and a second adhesive layer adhering the buffer layer to the skin. The buffer layer separates or isolates the wearable device from the skin. By mechanically buffering the wearable device from the skin, the multilayered adhesive structures permit the devices to be skin-mounted for an extended period of time (e.g., a few hours or days) without causing moisture-associated skin injuries such as erythema, maceration, and irritation or inflammation.

### CROSS-REFERENCE TO RELATED APPLICATION

This application is a Continuation-in Part Application of U.S. patent application Ser. No. 15/183,513, entitled, “Moisture Wicking Adhesives for Skin-Mounted Devices,” filed Jun. 15, 2016, which claims the benefit of and priority to U.S. Provisional Application No. 62/175,785, entitled, “Moisture Wicking Adhesives for Skin-Mounted Devices” filed Jun. 15, 2015, the contents each of which are incorporated by reference. This application also claims any and all benefits as provided by law, including the benefit under 35 U.S.C. § 119(e) of U.S. Provisional Application No. 62/437,162, entitled, “Buffered Adhesive Structures for Wearable Patches” filed Dec. 21, 2016, which is hereby incorporated by reference in its entirety.

### STATEMENT REGARDING FEDERALLY SPONSORED RESEARCH

Not Applicable.

### REFERENCE TO MICROFICHE APPENDIX

Not Applicable.

### BACKGROUND

### Technical Field of the Invention

This invention generally relates to buffered adhesive structures for mounting devices onto the skin.

### Description of the Prior Art

Some wearable devices are affixed to the skin using an adhesive and some of these devices have features, components or projecting elements that directly face and project into the skin. For people with sensitive skin, such as children, these projecting features can leave a lasting imprint on the subject's skin and cause skin irritation which limits the length of time the device can be worn.

### SUMMARY OF THE INVENTION

The invention relates to wearable devices that can be attached to the skin by one or more adhesive layers. In accordance with some embodiments of the invention, the adhesive layer can include a multilayered adhesive structure that includes one or more buffer layers and provides improved comfort and reduces the potential for skin irritation from the wearable devices. The multilayered adhesive structures according to embodiments of the invention can serve to decouple the wearable device from the skin by incorporating one or more buffer layers (e.g., a fabric layer, a synthetic material layer and/or a natural material layer) into the multilayered adhesive structure. In accordance with some embodiments, by mechanically decoupling the wearable device from direct contact with the skin, the adhesive structures permit the devices to be worn on the skin for an extended period of time (e.g., a few hours or a few days) without causing skin irritation.

In one aspect, the invention relates to a wearable device that includes a base substrate having a first surface and a second surface, and an integrated circuit mounted to the second surface of the base substrate. Circuit traces can be mounted on the first surface, the second surface or both surfaces of the base substrate. The multilayered adhesive structure can be adhered to the second surface of the base substrate. The multilayer adhesive structure can include a buffer layer having a first surface and a second surface and a first adhesive layer adhering the first surface of the multilayer adhesive structure to the second surface of the wearable device and a second adhesive layer adhering the second surface of the multilayer adhesive structure to the skin of the user. The first adhesive layer and the second adhesive layer can include a biocompatible pressure sensitive adhesive. In accordance with some embodiments of the invention, the multilayer adhesive structure can be removable from the wearable device and can be disposable or reusable.

In accordance with some embodiments of the invention, the buffer layer can include a felted fabric layer, a woven fabric and/or a mesh fabric layer. In accordance with some embodiments of the invention, the buffer layer can include a microfiber, polymer and/or elastomer material, and/or a natural material such as cotton, silk, hemp, bamboo, paper and/or a natural rubber. In accordance with some embodiments of the invention, the buffer layer can be 15 μm to 500 μm thick. In accordance with some embodiments of the invention, the buffer layer can include silk.

In accordance with some embodiments of the invention, the wearable device can be selected from the group consisting of an electronic device, a photonic device, an optoelectronic device, or combinations thereof.

In accordance with some embodiments of the invention, the second adhesive layer completely covers the buffer layer.

In accordance with some embodiments of the invention, the second adhesion layer comprises a skin adhesive selected from the group consisting of silicone gel adhesive, a silicone pressure sensitive adhesive, an acrylic pressure sensitive adhesive, a natural or synthetic rubber adhesive, a hydrocolloid adhesive, and a hydrogel adhesive.

In accordance with some embodiments of the invention, the first adhesion layer can be in the range from approximately 15 μm to 500 μm thick. In accordance with some embodiments of the invention, the second adhesion layer can be in the range from approximately 15 μm to 500 μm thick.

In accordance with some embodiments of the invention, the wearable device can include an antenna that permits short-range wireless communication. In some embodiments, the short-range wireless communication includes near field communication (NFC) or radio-frequency identification (RFID).

In accordance with some embodiments of the invention, the base substrate is comprised of polyimide, silicone, PDMS polyethylene terephthalate, polyester, polyurethane, polycarbonate, or a combination thereof.

In accordance with some embodiments of the invention, at least a portion of the structure is conformal.

In another aspect, the invention relates to a wearable device comprising: a base substrate having a first side and a second side; and at least one metal loop disposed on the first side or the second side of the base substrate. The wearable device also includes a chip or an integrated circuit disposed on the first side of the base substrate and electrically connected to the at least one metal loop. The wearable device further including a buffer layer having a first surface and a second surface, a first adhesion layer adhering to the second surface of the base substrate and to the first surface of the buffer layer, and a second adhesion layer adhering to the second surface of the buffer layer and adapted to adhere the wearable device to the skin. In accordance with some embodiments of the invention, the buffer layer can be removable from the wearable device and can be disposable or reusable.

In accordance with some embodiments of the invention, the metal loop can be 15 μm to 500 μm thick. In accordance with some embodiments of the invention, the metal loop can be comprised of a metal selected from the group consisting of copper, aluminum, gold, platinum, silver, silver paste, and paste with metallic nanoparticles.

These and other capabilities of the invention, along with the invention itself, will be more fully understood after a review of the following figures, detailed description, and claims.

### BRIEF DESCRIPTION OF THE DRAWINGS

The accompanying drawing figures, which are incorporated into this specification, illustrate one or more exemplary embodiments of the inventions and, together with the detailed description, serve to explain and illustrate the principles and applications of these inventions. The drawings and detailed description are illustrative, and not limiting, and can be adapted and modified without departing from the scope and spirit of the inventions.

FIG. 1A is a diagrammatic view showing a top down view of a wearable device in accordance with some embodiments of the invention.

FIG. 1B is a diagrammatic view showing a bottom view of the wearable device shown in FIG. 1A.

FIG. 2 shows a cross-sectional exploded view of a wearable device and a multilayered adhesive structure in accordance with some embodiments of the invention.

FIG. 3 shows a cross-sectional view of a wearable device assembly including a multilayered adhesive structure in accordance with some embodiments of the invention.

FIG. 4 shows a diagrammatic cross-sectional view of a wearable device including a multilayered adhesive structure according to some embodiments of the invention.

FIG. 5 is a schematic showing the operation of a flexible device in accordance with some embodiments of the invention.

FIG. 6 shows an isometric exploded view of a multilayer adhesive structure in accordance with some embodiments of the invention.

FIG. 7 shows a cross-sectional view of a wearable device applied to a skin surface in accordance with some embodiments of the invention.

### DETAILED DESCRIPTION OF THE ILLUSTRATED EMBODIMENTS

The present invention is directed to a multilayered adhesive structure having a buffer layer providing a material that separates and decouples the wearable device from the skin. The multilayered adhesive structure can be used to mount a wearable device, such as an electronic device, to a surface of a body, such as a human or animal body (e.g., on the skin), either directly (e.g., attached to the skin) or indirectly (e.g., attached to a covering layer, such as clothing, bandage, etc.). Thus, by mechanically decoupling the wearable device, the adhesive structures permit the devices to be skin-mounted for an extended period of time (e.g., a few hours or days) without causing skin injuries such as erythema, irritation and inflammation.

The multilayered adhesive structure can be used to adhere a wearable device to the skin (or any organ) for tagging, labeling, tracking sensing, monitoring, and/or diagnosing the subject. The wearable device can be an electronic device, an optical device, an optoelectronic device, or any combinations thereof. The multilayered adhesive structure can include a first adhesive layer applied and/or adhered to at least a portion of the surface on the first side of buffer layer and a second adhesive layer applied and/or adhered to the surface on the second side (opposite to the first) of the buffer layer. The first adhesive layer can include an adhesive material specifically selected to adhere the multilayered adhesive structure to the wearable device and the second adhesive layer can include an adhesive material specifically selected to adhere the wearable device to the skin of the user or a surface of an object.

As a non-limiting example, the wearable device can include an user-authentication component, mobile-payment component, and/or location-tracking electronic component. The wearable device can include one or more accelerometers, temperature sensors, neurological sensors (e.g., EEG), hydration sensors, heart sensors (e.g., ECG), motion sensors, flow sensors, pressure sensors, respiration sensors, skin conductance sensors, or any combinations thereof. The wearable device can include one or more treatment or therapy components including an electrical or neural stimulation component, a thermal (e.g., heat, radiation, cold, or cryo-therapy/ablation, etc.) treatment delivery component, an electromagnet radiation (e.g., visible and invisible light, RF radiation, microwave) delivery component, and audio (e.g., ultrasound) stimulation component. In accordance with some embodiments of the invention, the wearable device can be in wired or wireless communication with an external device such as a smart phone, a computer, a set-top box, an electronic pad or tablet, and a watch. In some embodiments, the multilayered adhesive structure can include one or more flexible antennas for wireless communication (e.g. NFC or RFID).

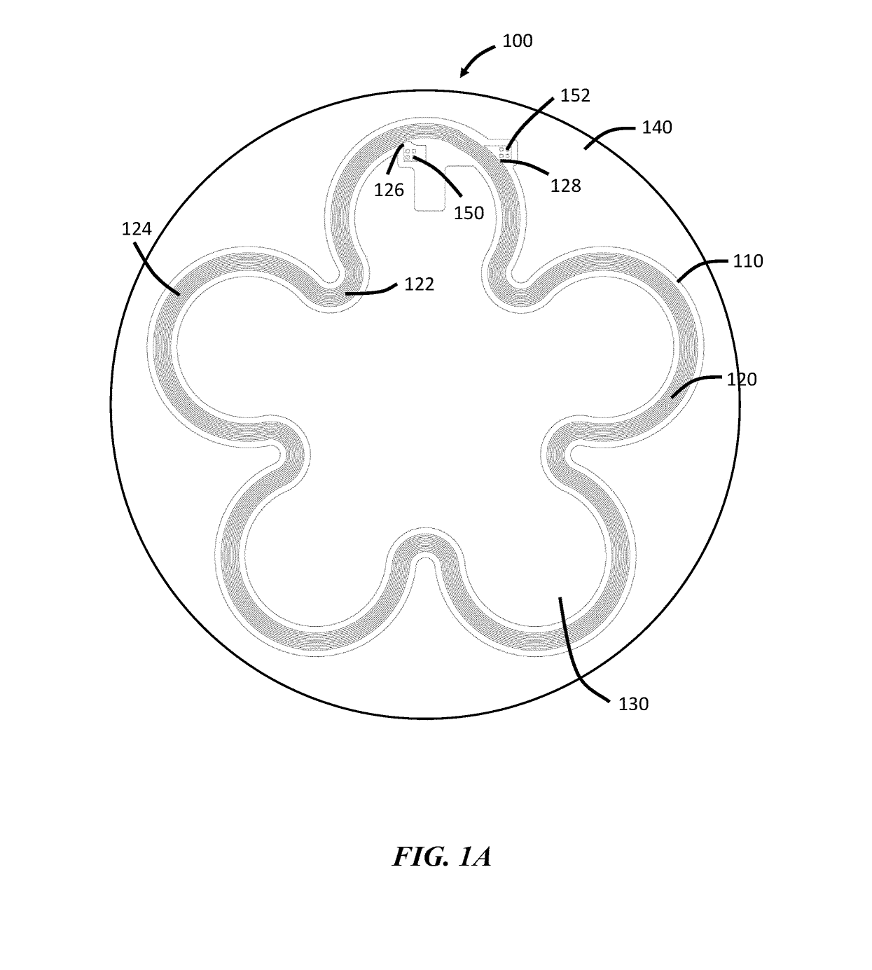

FIG. 1A shows a top down view of a wearable device 100 in accordance with some embodiments of the invention, and FIG. 1B shows a view from an opposite or bottom side of the same wearable device 100. The wearable device 100 can include a base substrate 110, and a plurality of conductive (e.g., metal) loops (e.g., 2, 3, 4, 5, 6, 7, 8, 9, 10, or more) arranged in a concentric manner and disposed on a first side of the base substrate 110 to form a flexible or stretchable antenna 120. Varying the number of metal loops can be used to adjust the electrical properties of the antenna, such as the inductance and the mutual inductance to the antenna from the reading components. In accordance with some embodiments of the invention, the space between the metal loops can be sufficient to avoid shorting during use and flexing or stretching. In accordance with some embodiments of the invention, the metal loops of the antenna 120 can be equally spaced apart by a distance on the order of microns, for example, by 5 μm to 150 μm, 10 μm to 120 μm, 10 μm to 100 μm, 20 μm to 80 μm, 30 μm, 40 μm, 50 μm, 60 μm, 75 μm, or 90 μm.

Each of the plurality of metal loops of the antenna 120 can be electrically connected, thereby forming an induction coil and/or an antenna. The plurality of metal loops of the antenna 120 can comprise a starting point 126 and an ending point 128. To form the metal loops 120, a continuous metal trace can start from the starting point 126, form a plurality of loops, and terminate at the ending point 128. In accordance with some embodiments of the invention, the starting point 126 is electrically connected to at least one via (e.g., a through hole) 150. The via permits the antenna 120 to be electrically connected to a chip or an integrated circuit on a second side of the base substrate 110. In accordance with some embodiments of the invention, the ending point 128 is electrically connected to at least one via (i.e., through hole) 152. In accordance with some embodiments of the invention, the starting point 126 can be electrically connected to at least one solder pad to facilitate a solder connection to a chip, an integrated circuit or another electronic device. In accordance with some embodiments of the invention, the ending point 128 can be electrically connected to at least one solder pad to facilitate a solder connection to a chip, an integrated circuit or another electronic device.

In accordance with some embodiments of the invention, the base substrate 110 can comprised of a polymer. A variety of polymeric materials can be suitable for forming the base substrate. Exemplary materials include, but are not limited to, polyimide, polyethylene terephthalate, polyethylene naphthalate, polyester, polyurethane, polycarbonate, polyethersulfone, cyclic olefin polymer, polyarylates, or a combination thereof. Preferably, the material can be flexible and/or stretchable at the thickness specified herein. In accordance with some embodiments of the invention, the base substrate can serve as the encapsulation layer.

In accordance with some embodiments, the base substrate 110 can have a thickness of no more than 300 μm. In accordance with other embodiments, the base substrate 110 can be thicker than 300 μm. Generally, thin base substrates tend to be more flexible and in some embodiments, the base substrate can be omitted or removed. In some embodiments of the invention, the thickness of the base substrate 110 is no more than 250 μm, no more than 200 μm, no more than 150 μm, no more than 100 μm, no more than 50 μm, or no more than 25 μm.

In accordance with some embodiments of the invention, the wearable device 100 can optionally include a cutout 130 where a portion of the base substrate 110 inside the innermost metal loop can be removed. For example, at least 5%, at least 10%, at least 20%, at least 30%, at least 40%, at least 50%, at least 60%, at least 70%, at least 80%, or at least 90% of the base substrate material inside the innermost metal loop is removed. As used herein, the term “innermost metal loop” refers to the first metal loop formed by the metal trace starting at the starting point 126. The cutout 130 can have any geometric shape. For example, the cutout 130 can have a shape that is substantially similar to the shape of the antenna 120. The cutout 130 can have a predefined shape (e.g., a predefined geometric or abstract shape) that facilitates stacking and/or storing the electronic device.

The lateral dimension of the wearable device 100 can be on the order of millimeters, for example, in the range of 5 mm to 45 mm, 10 mm to 40 mm, or 25 mm to 35 mm. And while the wearable device 100 shown in FIGS. 1A-1C are shown to have a round or circular shape, the wearable device can be formed in other shapes, including, square, rectangular, a polygon with any number of sides, and irregular shapes or symbolic shapes, such as, a face or head, a hand, a heart, alphanumeric symbols, and logos. In addition, the size of the wearable device can be any size, for example, as long as 100-200 mm or part of a larger wearable device that covers a predefined part of the body, for example, like a cast or brace (e.g., a foot brace, a knee brace, an wrist brace, an arm brace, a shoulder brace, or a neck brace).

As shown in FIG. 1B, the wearable device 100 can include a second side of the base substrate 110, vias 150 and 152, a first solder pad or electrode 160, and a second solder pad or electrode 162. The via 150 can be electrically connected to the first electrode 160, and the via 152 can be electrically connected to the second electrode 162. A chip or an integrated circuit can be electrically connected (such as by soldering or bonding wires) to the first electrode 160 and the second electrode 162, such that the antenna 1200 can provide power and wireless signals to the chip or integrated circuit 170.

In accordance with some embodiments of the invention, the wearable device 100 can be sandwiched between a flexible or stretchable encapsulation layer 140 (shown in FIG. 1A) and a flexible or stretchable multilayer adhesive component 142 (shown in FIG. 1B). In accordance with some embodiments of the invention, the wearable device 100 can be embedded or encapsulated between two encapsulation layers, such that flexing the encapsulation layer flexes the wearable device 100. The multilayer adhesive component can be coupled (e.g., adhered, bonded, or fastened) to one of the encapsulation layers, such as the bottom or lower encapsulation layer.

The flexible or stretchable antenna 120 described herein can be electrically connected to one or more chips or integrated circuits 170 to provide power and for short-range wireless communication such as near field communication (NFC), Bluetooth, Zigbee, radio-frequency identification (RFID), and WiFi. In some embodiment, infrared transmission can also be provided. The chip or integrated circuit can perform one or more functions. For example, the chip or integrated circuit can produce a signal (e.g., a data signal or an analog signal) for authentication of the wearable device and the wearer (e.g., to provide access to a device or a facility, or as part of a payment system). Accordingly, one aspect of the invention relates to a flexible or stretchable device 100 comprising the flexible or stretchable antenna 120 described herein and a chip or an integrated circuit 170 electrically connected to the antenna 120. In accordance with other embodiments of the invention, the flexible device 100 can include a multilayer adhesive component 142. The multilayer adhesive component 142 permits the flexible device to be affixed on a surface, such as the skin, a device or a fabric. The multilayer adhesive component can further include a release liner to protect the adhesive from contamination when not in use. In accordance with some embodiments of the invention, the chip or integrated circuit 170 can be in contact with the adhesive layer. In accordance with other embodiments of the invention, the chip or integrated circuit 170 can be in contact with the encapsulation layer on the opposite side from the multilayer adhesive component. Optionally, graphics (e.g., images and/or indicia) can be printed on the surface of or embedded in the encapsulation layer, the adhesive layer or both. In accordance with some embodiments of the invention, the graphics can include fluorescent, phosphorescent, luminescent (e.g., glows in the dark) or otherwise light or heat sensitive materials or components (e.g., materials that change in one or more characteristics as function of exposure to light and/or heat). For example, in accordance with some embodiments, at least a portion of the ink used to apply the graphics can change color as a function of exposure or duration of exposure to heat or light or other electromagnetic radiation.

In accordance with some embodiments of the invention, the flexible or stretchable wearable device can include two or more chips or integrated circuits, which can be optionally electrically connected by wires or using wireless signals. In accordance with some embodiments of the invention, the flexible or stretchable wearable device can include an on-board power source (e.g., a battery, storage capacitor, and/or photovoltaic cell) connected to the chip or integrated circuit 170.

The flexible electronic devices according to the invention can be configured without an on-board power source, enabling the degree of conformality of the flexible electronic device to be greatly increased. The flexible electronic devices herein can be configured in new form factors allowing the creation of very thin and flexible or stretchable electronic devices. As a non-limiting example, the average thickness of the flexible electronic device can be about 2.5 mm or less, about 2 mm or less, about 1.5 mm or less, about 1 mm or less, about 500 microns or less, about 100 microns or less, about 75 microns or less, about 50 microns or less, or about 25 microns or less. In an example implementation, at least a portion of the electronic device can be folded, or the electronic device can be caused to surround and conform to a portion of an irregular surface. In an example where at least a portion of the electronic device is folded, the average thickness of the electronic device may be about 5 mm or less, about 4 mm or less, about 3 mm or less, about 2 mm or less, about 1 mm or less, about 200 microns or less, about 150 microns or less, about 100 microns or less, or about 50 microns or less. The lateral, in-plane dimensions can be varied based on the desired application. For example, the lateral dimensions can be on the order of centimeters or fractions of a centimeter. In other examples, the flexible or stretchable electronic devices can be configured to have other dimensions, form factors, and/or aspect ratios (e.g., thinner, thicker, wider, narrower, or many other variations).

In accordance with some embodiments of the invention, the antenna of the wearable device can also be flexible or stretchable. In accordance with some embodiments of the invention, the flexible antenna or device comprising the antenna can conform to any surface (e.g., on a human or animal body or an irregular shaped device) to which it is applied. In accordance with some embodiments of the invention, the flexible antenna or device comprising the antenna can be substantially planar or flat in a resting state. In accordance with some embodiments of the invention, the flexible antenna or device comprising the antenna can be curved in a resting state, e.g., as on a curved surface, such as a ball or handle.

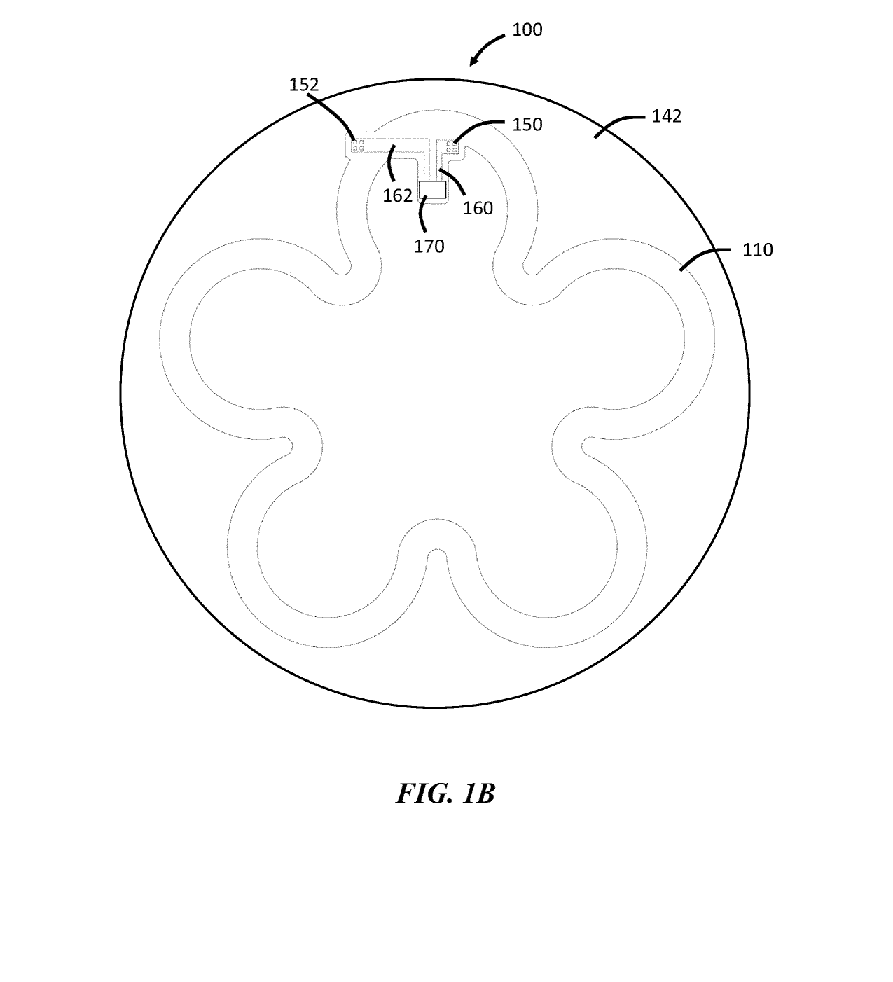

FIG. 2 shows an illustration of a diagrammatic exploded cross-section view of a wearable device 100 having a multilayered adhesive structure 200 in accordance with some embodiments of the invention. The wearable device can be configured in the form of a multilayer structure. The top layer 140 (away from the skin) can be an encapsulation layer that adds protection to the flexible printed circuit board 110 (flex PCB) and the die and serves as the base for optional graphic printing 144. The middle layer can include a flex PCB layer 110 (e.g., 1 or more layers with conductive, e.g., copper, traces 120) with a bare die (e.g., an NFC IC) attached. An optional, bottom encapsulation layer 146 can also be provided to protect the bottom surface of the flex PCB layer 110, for example, when the adhesive layer is removable. The bottom layer can include a multilayer adhesive structure 200 that decouples the wearable device from area of the skin where it is attached. The flex PCB 110 can include an antenna 120 such as shown in FIGS. 1A-1B that spans at least a portion of the wearable device area. The top encapsulation layer 140 (and optional, bottom encapsulation layer 146) can be larger than the flex PCB and can be shaped to accommodate a graphic image and/or indicia printed 144 on the top layer. In accordance with some embodiments of the invention, the antenna 120 can be configured to have as many as up to 6 or more turns and have a flower like shape enabling the antenna 120 to flex and/or stretch with the skin of the wearer. In accordance with some embodiments of the invention, the flex PCB 110 can be configured as a narrow ribbon following the flower shape. In accordance with some embodiments of the invention, the center part of the wearable device, inside the antenna can be left empty or can include one or more electronic components. In accordance with some embodiments of the invention, the antennas can have other shapes and other dimensions.

The multilayer adhesive structure 200 can include a first adhesive layer 202 for adhering buffer layer 210 of the multilayer adhesive structure 200 to the bottom encapsulation layer 146 and a second adhesive layer (e.g., a skin adhesive layer) 204 for adhering the isolation layer 210 (and the wearable device 100) to the skin of the user. In some embodiments, the bottom encapsulation layer 146 can be omitted and the first adhesive layer 202 can be adhered directly to the bottom of the flex PCB layer 110. The buffer layer 210 can be a flexible or stretchable, woven, felted or mesh fabric that separates the wearable device from the skin of the user to reduce skin irritation. In accordance with some embodiments, the buffer layer 210 can include a microfiber (e.g., woven, felted or mesh) fabric, a silk (e.g., woven, felted or mesh) fabric. In accordance with some embodiments, the buffer layer 210 can include a synthetic material such as a polymer or elastomer material or a natural material, such as a silk, cotton, hemp, bamboo or other natural fabric. The fabric can be woven, felted or a mesh fabric and can be a blend of synthetic and natural materials. In accordance with some embodiments of the invention, the fabric can include synthetic and/or natural microfiber materials. In accordance with some embodiments of the invention, the fabric can include a combination or blend of two or more materials.

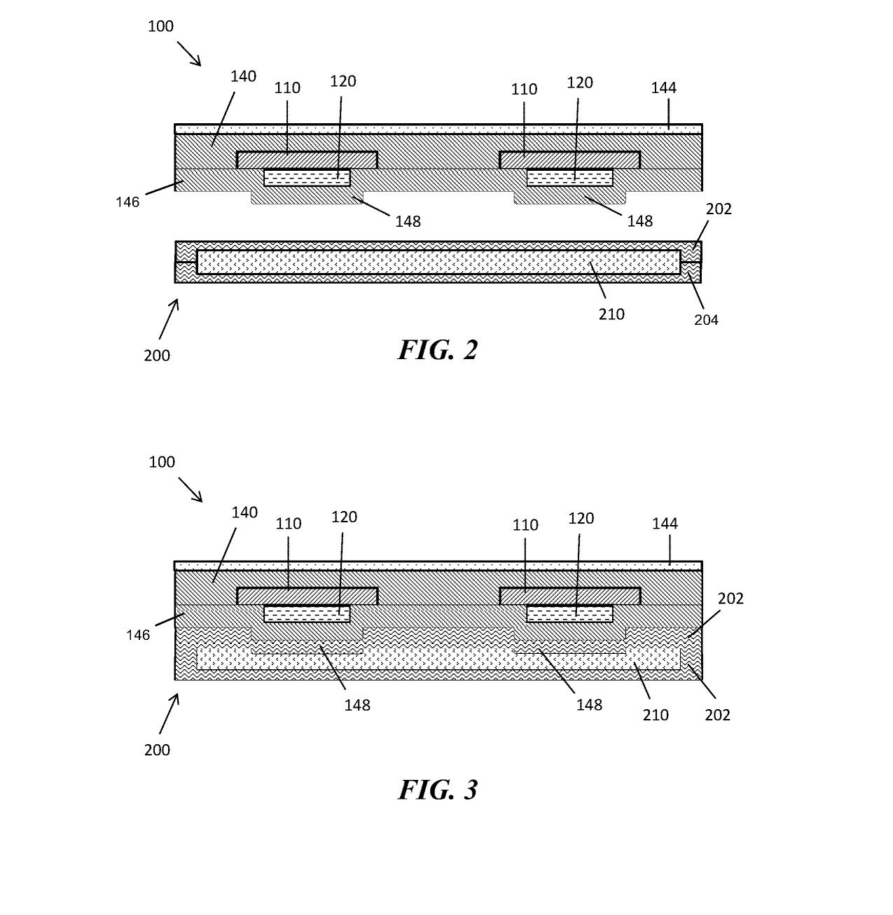

FIG. 3, similar to FIG. 2, shows an illustration of an assembled diagrammatic cross-section view of a wearable device 100 having a multilayered adhesive structure 200 in accordance with some embodiments of the invention. The wearable device 100 can be configured in the form of a multilayer structure. The top layer 140 (away from the skin) can include an encapsulation layer that adds protection to the flexible printed circuit board (flex PCB) 110 and the die, and serves as the base for optional graphic printing 144. The middle layer can include a flex PCB layer 110 with a bare die (e.g., an NFC IC) attached. The optional bottom encapsulation layer 146 can also be provided to protect the bottom surface to of the flex PCB layer 110. The bottom layer can include a multilayer adhesive structure 200 that decouples the wearable device from the skin. As shown in FIG. 3, the at least a portion 148 of the flex PCB layer 110, including the conductive traces 120 that form the antenna, can project from the bottom surface of the flex PCB layer 110 deforming the bottom encapsulation layer 146 and multilayer adhesive structure 200. This projection can possibly cause skin irritation. As shown in FIG. 3, the projecting portions 148 can possibly extend and deform the top surface of the multilayer adhesive structure 200 without projecting through into the skin, thus reducing the potential for skin irritation.

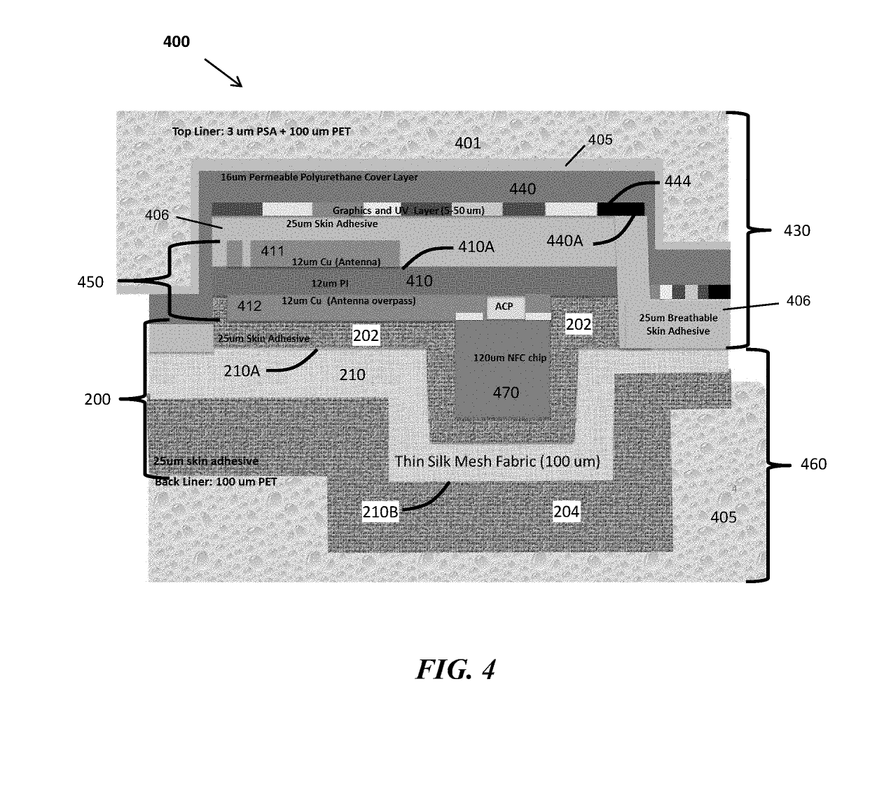

FIG. 4 shows a cross-section view of the wearable device 400 having a multilayer adhesive structure according to some embodiments of the invention. The wearable device 400 can include a first layer 430, a second layer 450 and a third layer 460. The first layer 430 can include the top encapsulation layer 440 and other optional layers include a first liner 401 (e.g., to protect the encapsulation layer and facilitate handling of the very thin wearable devices), a graphics layer 444 (e.g., for printing images and indicia), and a first adhesive layer 406 (e.g., to secure the bottom surface 440A of the top encapsulation layer to the top surface 410A of the flex PCB 410). Alternatively, the top encapsulation layer 440 can be self-adhering, for example, by being cast in place or heated causing the encapsulation layer to adhere directly to the top surface of the flex PCB 410. The top encapsulation layer 440 and, optionally, the first adhesive layer 406 can be constructed using breathable or porous materials. In accordance with some embodiments of the invention, the first adhesive layer 406 can include a skin adhesive. In accordance with some embodiments of the invention, the first adhesive layer can include acrylic-based, dextrin based, and urethane based adhesives as well as natural and synthetic elastomers, including, for example, amorphous polyolefins (e.g., including amorphous polypropylene), Kraton® Brand synthetic elastomers, and natural rubber. Other exemplary skin adhesives include cyanoacrylates, hydrocolloid adhesives, hydrogel adhesives, and soft silicone adhesives. In accordance with some embodiments of the invention, the skin adhesive can include FLEXCON DERMAFLEX™ H-566. In accordance with some embodiments of the invention, the adhesive can be reusable, enabling the device to be removed and reapplied or relocated and applied to different surface. In accordance with some embodiments of the invention, the first adhesive layer 406 can be in the range from 15 μm to 500 μm thick. In some embodiments the first adhesive layer 406 is about 25 μm thick. Likewise, the adhesive layers 202 and 204 can be from 15 μm to 500 μm thick, for example 25 μm thick.

The graphics layer 444 (e.g., images and/or indicia) can be printed on the surface of or embedded in the first layer 440, specifically adhered to the bottom surface 440A of the encapsulation layer 440. In accordance with some embodiments of the invention, the graphics layer 444 can include fluorescent, phosphorescent, luminescent (e.g., glows in the dark) or otherwise light or heat sensitive (e.g., changes in one or more characteristics as function of exposure to light and/or heat). For example, in accordance with some embodiments, at least a portion of the ink used to apply the graphics layer 444 can change color as a function of exposure or duration of exposure to heat or light or other electromagnetic radiation. In some embodiments the graphics and UV layer can be about 5 to 50 μm thick.

The encapsulation layer 440 can provide multiple functions. For example, the encapsulation layer 440 can provide mechanical protection of the flex PCB 410 and/or electrical isolation of the electronic components on the flex PCB 410. The encapsulation layer 440 can provide protection while providing a wide range of flexibility and stretchability, for example, using PDMS and silicone base encapsulation materials. In some embodiments encapsulation layer 440 includes or is a permeable layer such as a polyurethane cover layer (e.g., 16 μm thick). The encapsulation layer 440 can also be used as a passivation layer on top of other materials and/or devices that provide for the mechanical protection and/or electrical isolation. The encapsulation layer 440 can also relieve strains and stresses on the electronic device, such as the antenna of the device that is vulnerable to strain induced failure. A release liner 401 can be adhered to the top encapsulation layer 440 by layer 405 having an adhesive or other tacky materials. The release liner 401 and the top encapsulation layer 440 can each independently have the same or a different shape such as rectangular, circular, elliptical, oval, octagonal, hexagonal, and polygonal or an irregular shape. In some embodiments the top liner 401 can include a pressure sensitive adhesive (PSA), for example a 4 μm thick, on a polymer film such as polyethylene terephthalate (PET) for example 100 μm thick.

The second layer 450 can include a base substrate 410 and an integrated circuit 470. Second layer 450 can include antenna 411 and 412 (antenna overpass). As explained above, the base substrate 410 can have a thickness of no more than 300 μm. In some embodiments, thin base substrates are preferred as they tend to be more flexible and in some embodiments, the base substrate can even be omitted or removed. In some embodiments, the thickness of the base substrate 410 can be no more than 250 μm, no more than 200 μm, no more than 150 μm, no more than 100 μm, no more than 50 μm, or no more than 25 μm. The base substrate 410 can be physically separated into a plurality of singulated substrates (e.g., 2, 3, 4, 5, 6, 7, 8, 9, 10, or more), wherein at least one metal loop (e.g., an antenna structure) is disposed on each singulated substrate. Furthermore, the integrated circuit 470 can be provided for short-range wireless communication such as near field communication (NFC), Bluetooth, Zigbee, radio-frequency identification (RFID), and infrared transmission. The chip or integrated circuit 470 can perform one or more functions. For example, the chip or integrated circuit can produce a signal for authentication. Accordingly, one aspect of the invention relates to a flexible device comprising the flexible antenna described herein and a chip or an integrated circuit electrically connected to the antenna. In some embodiments the NFC chip can be about 120 μm thick, for example protruding into the multilayer adhesive structure 200.

The third layer 460 can include a multilayer adhesive structure 200 and a second release liner 405 (e.g., to protect the multilayer adhesive structure from contamination when not in use. The multilayer adhesive structure 200 can include a second adhesive layer 202, a buffer layer 210, and a third adhesive layer 204. The third adhesive layer 204 can be the bottom layer that is adapted for contact and adhesion to the skin. The buffer layer 210 includes a first surface 210A adhered to the second layer 450 by the second adhesive layer 202 and a second surface 210B adhered to the skin or other surface by third adhesive 204. Furthermore, the third adhesive layer 204 can include a skin adhesive which can be an unsupported transfer or double-coated adhesive. Any skin adhesives known in the art can be used in adhesives according to the invention. Suitable skin adhesives include acrylic-based, silicone-based, hydrocolloid-based, dextrin-based, and urethane-based adhesives, as well as natural and synthetic elastomers. Suitable examples include amorphous polyolefins (e.g., including amorphous polypropylene), KRATON® Brand synthetic elastomers, and natural rubber. Other exemplary skin adhesives include acrylic adhesives, cyanoacrylates, hydrocolloid adhesives, hydrogel adhesives, soft silicone adhesives, and silicone pressure sensitive adhesives. In accordance with some embodiments of the invention, the skin adhesive can comprise a silicone gel. In accordance with some embodiments of the invention, the skin adhesives can comprise an acrylic pressure sensitive adhesive. The third adhesive layer 204 can further comprise additives such as tackifiers, anti-oxidants, processing oils, and the like. Furthermore, the third adhesive layer 204 can further include a release liner 405, for example a 100 μm thick PET film.

The buffer layer 210 enables the second layer 450 to be attached to the skin or other surface and at the same time provides a buffer that separates or isolates and decouples the features of the second layer 450 from the skin or surface and provides more conformal contact in order to reduce or avoid skin irritation. In some embodiments the buffer layer made of a silk mesh fabric 100 μm thick. In accordance with some embodiments of the invention, the first surface 210A of the buffer layer 210 can be attached to the skin facing or bottom side of the wearable device 400 by the second adhesive layer 210 (e.g., the second adhesive layer 210 adheres to both the second layer 450 and the buffer layer 210). The second side 210B of the buffer layer 210 can be pre-laminated to the third adhesive layer 204. Both the second adhesive layer 202 and the third adhesive layer 204 can include the same skin-safe adhesive. In accordance with some embodiments, the buffer layer 210 can be sized to cover the base substrate 410 of the second layer 450 and can be smaller than the encapsulation or first layer 440 and the third adhesive layer 204. In accordance with some embodiments, the buffer layer 210 can be sized to cover more than the base substrate 410 of the second layer 450 and can be the same size or larger than the encapsulation or first layer 440 and the third adhesive layer 204.

In accordance with some embodiments of the invention, the buffer layer 210 can include a flexible or stretchable material, such as a woven, felted or mesh fabric. Examples of fabric materials include, but are not limited to moisture-wicking fabrics, silk, open-cell foams, and conductive nanofibrous films. The buffer layer 210 can include a felted, knitted, woven, and non-woven fabric. The buffer layer 210 can also be a blend of different synthetic materials, synthetic and natural materials or different natural materials, including, for example, polyester, spandex, nylon, polyester, cotton, wool, silk, hemp, and bamboo. In accordance with some embodiments of the invention, the buffer layer 210 can include two or more layers of fabric materials, including fabric layers held together by an adhesive, polymer or elastomer material. In accordance with some embodiments of the invention, the buffer layer 210 can include a quilted fabric material. In accordance with some embodiments of the invention, the buffer layer 210 can be in the range from 15 μm to 500 μm thick. In some embodiments, the buffer layer 210 can be about 100 μm thick.

Less contact area between the third adhesive layer 204 and the skin can promote the comfort of wear and reduce the likelihood that moisture (e.g., perspiration and skin oils) can become trapped between the skin and the third adhesive layer 204. In an alternative embodiment, for example, the third adhesive layer 204 can comprise at least one cutout. The size of the cutout can be determined by ensuring that there is sufficient adhesion force between the third adhesive layer 204 and skin. The cutout can have any shape provided that there is sufficient adhesion force between the third adhesive layer 204 and the skin. For example, the cutout can be circular, oval, diamond, triangular, square, rectangular, polygonal, or the shape of an opening in the base substrate. The third adhesive layer 403 can be textured to increase the adhesion force between the third adhesive layer 403 and the skin while reducing the contact area.

The adhesives structures of the present invention can be fabricated using standard coating or lamination equipment known to those skilled in the art. The adhesive structures can be fabricated in the form of tapes, pads, patches, or other regular or irregular shaped adhesive elements, having any shape or size.

In accordance with some embodiments of the invention, at least a portion of the multilayer adhesive structure 200 can be flexible. For example, the first adhesion layer 202 can be flexible or stretchable. In accordance with some embodiments of the invention, the adhesive structure 200 can take the form of a flexible double-sided adhesive structure or unsupported transfer adhesive.

In accordance with some embodiments of the invention, at least a portion of the multilayered adhesive structure 200 can be stretchable or flexible. For example, the third adhesive layer 204 can be stretchable. In accordance with some embodiments of the invention, the multilayered adhesive structure 200 can take the form of a stretchable double-sided adhesive structure or unsupported transfer adhesive.

In accordance with some embodiments of the invention, at least a portion of the multilayered adhesive structure 200 can be conformal. For example, the first adhesion layer can be conformal. In accordance with some embodiments of the invention, the multilayered adhesive structure 202, 204, 210 can take the form of a conformal double-sided adhesive structure or unsupported transfer adhesive.

In some embodiments of the invention, technology is provided for qualitative and/or quantitative analysis using the flexible electronic devices that include no power source or a low-power source. As a non-limiting example, the low-power source could be power source providing lower than about 25 mAH, about 20 mAH, about 15 mAH, about 10 mAH, about 5 mAH, or about 1 mAH. In an example, the low-power source could provide lower than about 5 mA peak current, such as but not limited to a thin-film battery with sub-5 mA peak current. The flexible electronic devices can be configured for medical diagnostics, user authentication, mobile payments, and/or location tracking.

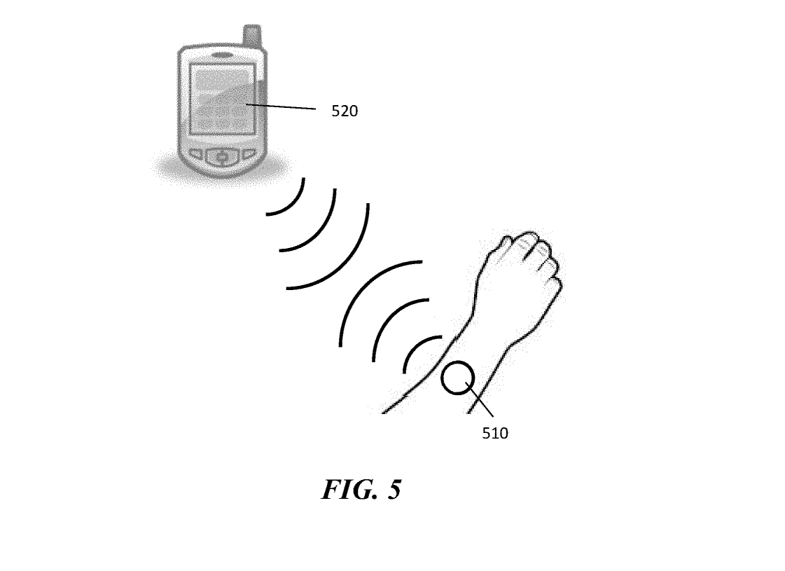

FIG. 5 shows a diagrammatic illustration of the operation of a wearable device 510 in accordance with some embodiments of the invention. The wearable device 510 can be mounted to the skin of a person, for example, on the forearm, the hand, the chest, the leg or the foot. A computing device 520 can be disposed at a distance from the wearable device 510 suitable for short-range wireless communication (e.g., NFC, RFID, Blue Tooth, WiFi, Zigbee, medical telemetry). For example, NFC is a set of short-range wireless technologies, typically requiring a distance of 10 cm or less. The computing device 520 can produce a signal (e.g., an electromagnetic wave) receivable by the wearable device 510. The wearable device 510 can include an antenna which can generate an electrical current in response to the signal. The electrical current can then power one or more chips or integrated circuits of the wearable device 510 to produce an outgoing signal, which can be received by the same computing device 510 or a different device. The outgoing signal can be used to perform one or more functions (including sensor data transfer, user authentication, mobile payments, and/or location tracking).

In accordance with some embodiments of the invention, the wearable device 510 can remain functional when mounted to the skin of a person and while flexing and/or stretching according to the movement of the skin. In accordance with some embodiments of the invention, at least a portion of the wearable device 510 can be breathable, enabling gas and vapor to flow away and toward the skin, enabling the wearable device 510 to be worn for long periods of time, on the order of days, weeks or months without causing skin irritation.

The wearable device 510 herein can be configured as a single-use device. For example, the device can stay functional when it is on the skin of a user, but will stop its functions once it is removed from the skin, for example, because the metal loops of the antenna, by design, break.

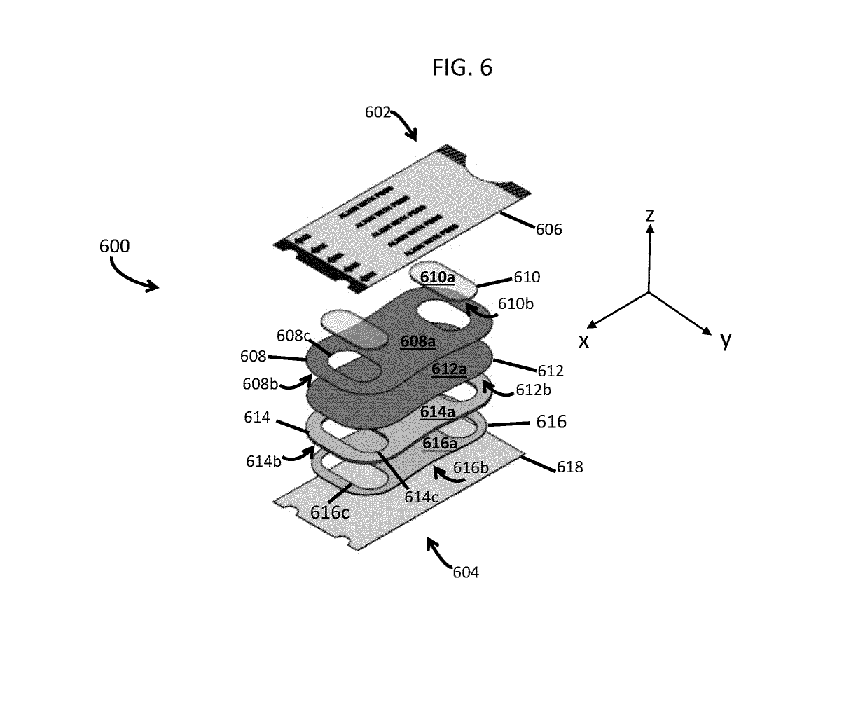

FIG. 6 shows an exploded view of a multilayer adhesive structure 600 in accordance with some embodiments of the invention. The multilayer stack-up of structure 600 can have a device side 604 wherein the device side 604 includes a device adhesive layer 616 adapted and configured to adhere the multilayer adhesive structure 600 to a wearable sensor device. The multilayer stack-up of structure 600 can have a skin side 602 wherein the skin side 604 includes a skin adhesive layer 608 adapted and configured to adhere the wearable sensor device to a surface or the skin of a subject. In accordance with some embodiments of the invention, the multilayer adhesive structure 600 can include a device adhesive layer 616, a buffer layer 614, an optional support layer 612, and a skin adhesive layer 608. The skin adhesive layer 608 can include a skin facing surface 608a and a device facing surface 608b adhered to either the optional support layer 612 or the buffer layer 614. The support layer 612 can include a skin facing surface 612a adhered to the skin adhesive layer 608 and a device facing surface 612b adhered to the buffer layer 614. The buffer layer 614 can include a skin facing surface 614a adhered to the support layer 612 and a device facing surface 614b adhered to the device adhesive layer 616. If the support layer is omitted, the skin facing surface 614a of the buffer layer 614 can be adhered to the skin adhesive layer 608. The device adhesive layer 616 can include a skin facing surface 616a adhered to the buffer layer 614 and a device facing surface 616b adapted to be adhered to the wearable sensor device.

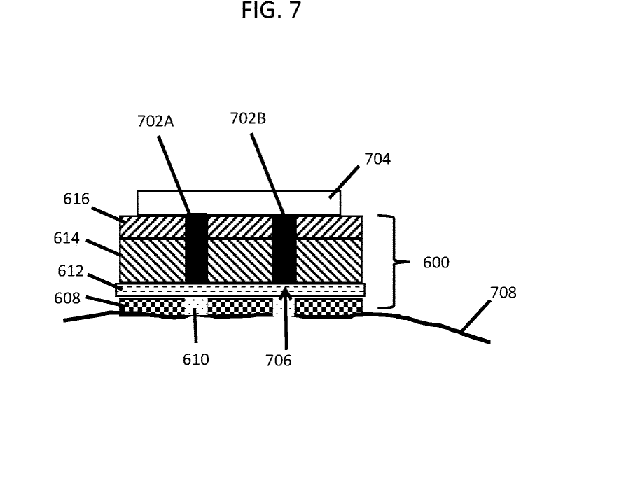

In accordance with some embodiments of the invention, the multilayer adhesive structure 600 can be used to stick or adhere a wearable sensor device 704 (FIG. 7) to a surface such as the skin of a subject. In accordance with some embodiments, the wearable sensor device can include electrodes 702A and 702B that can be used to detect bio-potentials from the surface. In order to accommodate the electrodes, the device adhesive layer 616 and buffer layer 614 can include one or more cutouts that enable to the electrodes to make contact with the support layer 612 and a hydrogel layer 610 supported by the support layer 612. In accordance with some embodiments, the support layer 612 can be permeable to the hydrogel and the hydrogel layer 610 can make direct contact with the electrodes 702A and 702B, such that when the wearable sensor device is worn on the skin, the hydrogel of the hydrogel layer 610 conducts bio-potentials to the electrodes. In accordance with some embodiments of the invention, the support layer 612 can be conductive and transmit signals and bio-potentials received from the surface through the hydrogel to the electrodes. In accordance with some embodiments of the invention, the skin adhesive layer 608 can also include one or more cutouts that define a space into which the hydrogel layer 610 can fit. In addition, the hydrogel layer 610 can be substantially the same thickness as the skin adhesive layer 608 to enable the hydrogel layer 610 to make sufficient contact with the surface to transmit bio-potential and other signals to the electrodes. In accordance with some embodiments, the hydrogel layer 610 can be slightly thicker (e.g., 0.1 mm) or thinner (e.g., 0.1 mm) than the skin adhesive layer to accommodate expansion and compression during use. In accordance with some embodiments, the support layer 612 can also include one or more cutouts and the hydrogel layer 610 can extend into the support layer 614 to make contact with the electrodes 702A, 702B enabling signals and bio-potentials to be detected by the electrodes 702A and 702B. In accordance with some embodiments of the invention, other conductive materials such as conductive polymers can be used in place of the hydrogel in the hydrogel layer 610.

In accordance with some embodiments of the invention, the wearable sensor device does include electrodes and the support layer 612 can be omitted from the corresponding multilayer adhesive structure 600. Thus, the resulting multilayer adhesive structure 600 can include a buffer layer 614 having a skin adhesive layer 608 on the skin side 602 and the device adhesive layer 616 on the device side 604.

In accordance with some embodiments of the invention, the support layer 612 can be attached to the skin by contacting the skin facing surface 612a of permeable layer 612 to the device facing surface 608b of the skin adhesive layer 608 and attaching the skin facing surface 608a of the skin adhesive layer 608 to the skin. The buffer layer 614 can include an adhesive on the skin facing surface 614a. The buffer layer 614 can be adhered to the support layer 612 by contacting an adhesive on the skin facing surface 614a with the device facing surface 612a of the support layer 612. The device adhesive layer 616 of the multilayer adhesive structure 600 can be attached to a wearable device 704 by contacting device facing surface 616b of the adhesive 616 with the surface (e.g., the skin facing surface) of the wearable device, and contacting the device facing surface 614b of buffer layer 614 to the skin facing surface 616a of device adhesive layer 616. The stack-up can also optionally include a first liner 606 on the skin facing side 602 of multilayer adhesive structure 600, for example, liner 606 can be removably attached to the skin facing surface 608a of skin adhesive layer 608. The stack-up can also include a second liner 618 on the device facing side 604 of structure 600, for example, liner 618 can be removably attached to the device facing surface 616b of device adhesive layer 616.

In the multilayer adhesive structure 600, the skin adhesive layer 608, the buffer layer 614 and device adhesive layer 616 can include a cutout. The periphery of the cutouts in layers 608, 614 and 616 are indicated in FIGS. 6 as 608c, 614c and 616c, respectively and shown in the section view in FIG. 7. The cutouts can have the same or different shapes and can be aligned along the Z direction when the adhesive stack up 600 is assembled for its intended use. By “aligned” it is understood that a projection onto an X-Y plane of cutouts in the layers 608 and 614, or 614 and 616, or 608 and 616, or in all three layers 608, 614 and 616 substantially overlap. By substantially overlap it is meant that the areas outlined by the projections of respective peripheries 608c, 614c and 614c overlap by about 100%, at least about 95%, at least 90%, at least 80%, at least 50%, at least 10%. In some embodiments the shapes are the same and overlap by at least about 95%. In some embodiments, the shapes are different and overlay by less than 50%.

The multilayer adhesive structure 600 can include a conductive material 610 that can be a layered material disposed, formed or shaped for placement into the cutout in first adhesive layer 608 (e.g., the conductive material 610 forms at least part of the first adhesive layer and can extend into the support layer 612). The conductive material 610 can include a device facing surface 610b and a skin facing surface 610a. The support layer 612 can include at least a portion that is permeable to the conductive material 610, at least until it is cured to a solid or semisolid state. Therefore, the conductive material 610 can flow into the support layer 612 through the skin facing surface 612a of support layer 612 up to the device facing surface 612b of the support layer 612. In accordance with some embodiments of the invention, the conductive material 610 can flow through the device facing surface 612b into one or more of the cutouts formed in the buffer layer 614 and make contact with electrodes projecting into the cutouts of the buffer layer 614. In some embodiments conductive material 610 is not permeable through layer 612 once it is cured so that the second layer 612 forms a barrier to the flow of cured material 612 once it is cured. The conductive material 610 can selected or configured to be in contact with the skin through its skin facing surface 610a once first liner 606 is removed.

FIG. 7 shows a cut out view of a device 704 attached to a skin surface 708 using multilayer adhesive structure 600. The cutouts in the buffer layer 614 and skin adhesive layer 616 can be configured (e.g., positioned and sized) to accept a part of the wearable device 704 adhered to the device facing side of multilayer adhesive structure 600. For example, as shown in FIG. 7, electrodes 702A, 702B on a device 704 can be aligned with the cutouts and the cutouts can be configured such that the electrodes 702A, 702B extend into the cutouts. An electrode working surface 706 of the electrode can be configured to contact the device facing surface 612b of second permeable layer 612. The working electrode surface 706 can contact conductive material 610 which is permeated through support layer 612 and thereby electrode 702A can be placed in electrical communication to the skin through conductive material 610 which is also in contact with skin. In accordance with some embodiments of the invention, the conductive material 610 can be replaced with a dielectric material and the electrodes can function as a capacitive electrode to receive signals from the surface.

In some embodiments the layers in the adhesive stack-up 600, such as, 612 and 616 are not removably attached to each other and/or skin. By not being removably attached it is implied that the stack-up cannot be used once detached from each other, the device or skin. For example, the layers may be damaged such as being warped, contaminated or torn so that they do not work properly (e.g., the device falls off the wearer or signals are not properly received to the attached device from the subject's skin). In some embodiments the multilayer adhesive structure 600 can be removably attached to a wearable device and/or skin, so that the wearable device can be removed and re-attached to the skin using structure 600 at least more than once (e.g., 2, 3, 4 or more times) and function as intended, and the multilayer adhesive structure 600 can be removed and re-attached to the wearable device 704 at least more than once (e.g., 2, 3, 4 or more times) and function as intended

The layers in multilayer adhesive structure 600 can be made utilizing any of the materials described herein. In some embodiments the release liners 602 and 604 can include a Polyethylene Terephthalate sheet coated with a release film, such as a 3 Mil thick (about 008 mm) Mylar® film (Dupont, Del.) coated with a silicone release agent. In some embodiments the skin adhesive layer 608 can include a medical grade acrylic adhesive such as a 4.5 mils thick (about 0.11 mm) film utilizing Polyken® 3558B (Berry Plastics, Mass.). In some embodiments the conductive material 610 can include a conductive material such as a skin safe polyelectrolyte. For example, in some embodiments, the conductive material 610 can include a hydrogel such as a low adhesion hydrogel for electrode stimulation and monitoring e.g., a 32 mil layer (about 0.81 mm) of KM 50F Hydrogel (Katecho Inc., Iowa). In some embodiments, the support layer 612 can include a felted fabric, mesh fabric, woven fabric, a matted fabric or a material such as a scrim or gauze. The material can include any one or more of silk, cotton, microfiber, nylon, polyester, hemp and bamboo. For example, layer 612 can include a Reemay® (polyester) Style 2004 (Fiberweb Inc., Tenn.) based material layer. In some embodiments the buffer layer 614 can include any one or more of polyimide, polyethylene terephthalate, polyester, polyurethane, polycarbonate and polyolefin, and optionally formed as a closed celled foam. For example, buffer layer 614 can include a closed cell polyolefin foam. In one embodiment layer 614 can include a 34 mil thick (about 0.86 mm) Polyolefin Foam Tape PN 1773 (3M Medical Specialties, Minn.). In some embodiments, the device adhesive layer 616 can include a double sided tape such as a polyethylene film (e.g., carrier) coated on both sides with an acrylic adhesive. For example, layer 616 can include a 13 mil thick (about 0.33 mm) medical tape such as 3M product number 1522H medical tape (3M Medical Specialties, Minn.).

The terms “flexible” and “bendable” are used synonymously in the present description and refer to the ability of a material, structure, device or device component to be deformed into a curved or bent shape without undergoing a transformation that introduces significant strain, such as strain characterizing the failure point of a material, structure, device or device component. In an exemplary embodiment, a flexible material, structure, device or device component can be deformed into a curved shape without introducing strain larger than or equal to 5%, for some applications larger than or equal to 1%, and for yet other applications larger than or equal to 0.5% in strain-sensitive regions. As used herein, some, but not necessarily all, flexible structures can be also stretchable. A variety of properties provide flexible structures (e.g., device components) of the invention, including material properties such as a low modulus, bending stiffness and flexural rigidity; physical dimensions such as small average thickness (e.g., less than 100 microns, optionally less than 10 microns and optionally less than 1 micron) and device geometries such as thin film and mesh geometries.

As used herein, “stretchable” refers to the ability of a material, structure, device, or device component to be strained (e.g., elongated) without undergoing fracture. In an exemplary embodiment, a stretchable material, structure, device or device component may undergo strain larger than 0.5% without fracturing, for some applications strain larger than 1% without fracturing and for yet other applications strain larger than 3% without fracturing. As used herein, many stretchable structures are also flexible. Some stretchable structures (e.g., device components) are engineered to be able to undergo compression, elongation and/or twisting so as to be able to deform without fracturing. Stretchable structures include thin film structures comprising stretchable materials, such as elastomers; bent structures (e.g., springs, serpentine and buckled structures) capable of elongation, compression and/or twisting motion; and structures having an island-bridge geometry. Stretchable device components include structures having stretchable interconnects, such as stretchable electrical interconnects.

As used herein, the term “conformable” refers to a device, material or substrate which has a bending stiffness sufficiently low to allow the device, material or substrate to adopt a desired contour profile, for example a contour profile allowing for conformal contact with a surface having a pattern of relief or recessed features. In certain embodiments, a desired contour profile is that of a surface of a tissue or an organ in a biological environment, for example skin.

As used herein, the term “conformal contact” refers to contact established between a wearable device and a receiving surface, which can for example be a target tissue in a biological environment. In one aspect, conformal contact involves a macroscopic adaptation of one or more surfaces (e.g., contact surfaces) of a wearable device to the overall shape of a tissue surface. In another aspect, conformal contact involves a microscopic adaptation of one or more surfaces (e.g., contact surfaces) of a wearable device to a tissue surface resulting in an intimate contact substantially free of voids. In some embodiments, conformal contact involves adaptation of a contact surface(s) of the wearable device to a receiving surface(s) of a tissue such that intimate contact is achieved, for example, wherein less than 20% of the surface area of a contact surface of the wearable device does not physically contact the receiving surface, or optionally less than 10% of a contact surface of the wearable device does not physically contact the receiving surface, or optionally less than 5% of a contact surface of the device does not physically contact the receiving surface. In some embodiments, the tissue is skin tissue. In accordance with some embodiments of the invention, conformal contact provides sufficient contact between the wearable device and skin or other surface to enable the wearable device to function as intended, for example, where wearable device includes sensors, the sensors are able to detect signals from the skin regardless of whether the skin is stationary, moving, stretching or flexing.

Embodiments of the various aspects described herein can be illustrated by the following numbered paragraphs.

1. A wearable device configured to be adhered to skin, comprising:
a base substrate having a first surface and a second surface;
an integrated circuit mounted to the second surface of the base substrate;
a buffer layer having a first surface and a second surface;
a first adhesion layer adhering to the second surface of the base substrate and to the first surface of the buffer layer; and
a second adhesion layer adhering to the second surface of the buffer layer and adapted to adhere the wearable device to the skin.

2. The wearable device of paragraph 1, wherein the buffer layer comprises a woven fabric layer.

3. The wearable device of paragraph 1 or 2, wherein the buffer layer comprises a felted fabric layer.

4. The wearable device of any one of paragraphs 1-3, wherein the buffer layer comprises a mesh fabric layer.

5. The wearable device of any one of paragraphs 1-4, wherein the buffer layer has a thickness of no more than 100 μm

6. The wearable device of any one of paragraphs 1-5, wherein the base substrate has a thickness of no more than 100 μm.

7. The wearable device of any one of paragraphs 1-6, wherein the integrated circuit further include an antenna configured to conform to the skin.

8. The wearable device of paragraph 7, wherein the antenna permits short-range wireless communication.

9. The wearable device of paragraph 8, wherein the short-range wireless communication is near field communication (NFC) or radio-frequency identification (RFID).

10. The wearable device of any one of paragraphs 1-9, wherein the base substrate is comprised of polyimide, polyethylene terephthalate, polyester, polyurethane, polycarbonate, or a combination thereof.

11. The wearable device of any one of paragraphs 1-10, wherein the buffer layer includes at least one of silk, cotton, microfiber, nylon, polyester, hemp, and bamboo.

12. A flexible device adapted to be attached to skin, the flexible device comprising:
an antenna providing short-range wireless communications, the antenna comprising:
   a base substrate having a first surface and a second surface; and
   at least one metal loop disposed on the base substrate;
a chip or an integrated circuit electrically connected to the at least one metal loop;
a buffer layer having a first surface and a second surface;
a first adhesive layer adhering to the second surface of the base substrate and to the first surface of the buffer layer; and
a second adhesive layer adapted to adhere the second surface of the buffer layer to the skin.

13. The flexible device of paragraph 12, wherein the antenna and the integrated circuit enable the flexible device to communicate using near field communication (NFC).

14. The flexible device of paragraph 12 or 13, wherein the buffer layer comprises a woven fabric layer.

15. The flexible device of any one of paragraphs 12-14, wherein the buffer layer comprises a felted fabric layer.

16. The flexible device of any one of paragraphs 12-15, wherein the buffer layer has a thickness of no more than 100 μm.

17. The flexible device of any one of paragraphs 12-16, wherein the base substrate has a thickness of no more than 100 μm.

18. The flexible device of any one of paragraphs 12-17, wherein the at least one metal loop has a thickness of no more than 100 μm.

19. The flexible device of any one of paragraphs 12-18, wherein the antenna is flexible or stretchable enabling the flexible device to conform to a surface to which it is applied.

20. The flexible device of any one of paragraphs 12-19, wherein the at least one metal loop is comprised of a metal selected from the group consisting of copper, tin, aluminum, gold, platinum, silver, silver paste, and paste with metallic nanoparticles.

21. The flexible device of any one of paragraphs 12-20, wherein the base substrate is comprised of polyimide, polyethylene terephthalate, polyester, polyurethane, polycarbonate, or a combination thereof.

22. The flexible device of any one of paragraphs 12-21, wherein the buffer layer includes at least one of silk, cotton, microfiber, nylon, polyester, hemp, and bamboo.

23. The flexible device of any one of paragraphs 12-22, wherein the chip or integrated circuit is mounted to the first surface of the base substrate.

24. The flexible device of any one of paragraphs 12-23, wherein the chip or integrated circuit is mounted to the second surface of the base substrate.

Other than in the operating examples, or where otherwise indicated, all numbers expressing quantities of ingredients or reaction conditions used herein should be understood as modified in all instances by the term “about.” The term “about” when used in connection with percentages may mean ±1% of the value being referred to. For example, about 100 means from 99 to 101.

The singular terms “a,” “an,” and “the” include plural referents unless context clearly indicates otherwise. Similarly, the word “or” is intended to include “and” unless the context clearly indicates otherwise.

Although methods and materials similar or equivalent to those described herein can be used in the practice or testing of this disclosure, suitable methods and materials are described below. The term “comprises” means “includes.” The abbreviation, “e.g.” is derived from the Latin exempli gratia, and is used herein to indicate a non-limiting example. Thus, the abbreviation “e.g.” is synonymous with the term “for example.”

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow. Further, to the extent not already indicated, it will be understood by those of ordinary skill in the art that any one of the various embodiments herein described and illustrated can be further modified to incorporate features shown in any of the other embodiments disclosed herein.

All patents and other publications; including literature references, issued patents, published patent applications, and co-pending patent applications; cited throughout this application are expressly incorporated herein by reference for the purpose of describing and disclosing, for example, the methodologies described in such publications that might be used in connection with the technology described herein. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

The description of embodiments of the disclosure is not intended to be exhaustive or to limit the disclosure to the precise form disclosed. While specific embodiments of, and examples for, the disclosure are described herein for illustrative purposes, various equivalent modifications are possible within the scope of the disclosure, as those skilled in the relevant art will recognize. For example, while method steps or functions are presented in a given order, alternative embodiments may perform functions in a different order, or functions may be performed substantially concurrently. The teachings of the disclosure provided herein can be applied to other procedures or methods as appropriate. The various embodiments described herein can be combined to provide further embodiments. Aspects of the disclosure can be modified, if necessary, to employ the compositions, functions and concepts of the above references and application to provide yet further embodiments of the disclosure.

Specific elements of any of the foregoing embodiments can be combined or substituted for elements in other embodiments. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

What is claimed is:

1. A wearable device configured to be adhered to skin, comprising:
a base substrate having a first surface and a second surface;
an integrated circuit mounted to the second surface of the base substrate;
a buffer layer having a first surface and a second surface;
a first adhesion layer adhering to the second surface of the base substrate and to the first surface of the buffer layer; and
a second adhesion layer adhering to the second surface of the buffer layer and adapted to adhere the wearable device to the skin.

2. The wearable device of claim 1, wherein the buffer layer comprises a woven fabric layer.

3. The wearable device of claim 1, wherein the buffer layer comprises a felted fabric layer.

4. The wearable device of claim 1, wherein the buffer layer comprises a mesh fabric layer.

5. The wearable device of claim 1, wherein the buffer layer has a thickness of no more than 100 μm.

6. The wearable device of claim 1, wherein the base substrate has a thickness of no more than 100 μm.

7. The wearable device of claim 1, wherein integrated circuit further includes an antenna configured to conform to the skin.

8. The wearable device of claim 7, wherein the antenna permits short-range wireless communication.

9. The wearable device of claim 8, wherein the short-range wireless communication is near field communication (NFC) or radio-frequency identification (RFID).

10. The wearable device of claim 1, wherein the base substrate is comprised of polyimide, polyethylene terephthalate, polyester, polyurethane, polycarbonate, or a combination thereof.

11. The wearable device of claim 1, wherein the buffer layer includes at least one of silk, cotton, microfiber, nylon, polyester, hemp, and bamboo.

12. A flexible device adapted to be attached to skin, the flexible device comprising:
an antenna providing short-range wireless communications, the antenna comprising:
a base substrate having a first surface and a second surface; and
at least one metal loop disposed on the base substrate;
a chip or an integrated circuit electrically connected to the at least one metal loop;
a buffer layer having a first surface and a second surface;
a first adhesive layer adhering to the second surface of the base substrate and to the first surface of the buffer layer; and
a second adhesive layer adapted to adhere the second surface of the buffer layer to the skin.

13. The flexible device of claim 12, wherein the antenna and the integrated circuit enable the flexible device to communicate using near field communication (NFC).

14. The flexible device of claim 12, wherein the buffer layer comprises a woven fabric layer.

15. The flexible device of claim 12, wherein the buffer layer comprises a felted fabric layer.

16. The flexible device of claim 12, wherein the buffer layer has a thickness of no more than 100 μm.

17. The flexible device of claim 12, wherein the base substrate has a thickness of no more than 100 μm.

18. The flexible device of claim 12, wherein the at least one metal loop has a thickness of no more than 100 μm.

19. The flexible device of claim 12, wherein the antenna is flexible or stretchable enabling the flexible device to conform to a surface to which it is applied.

20. The flexible device of claim 12, wherein the at least one metal loop is comprised of a metal selected from the group consisting of copper, tin, aluminum, gold, platinum, silver, silver paste, and paste with metallic nanoparticles.

21. The flexible device of claim 12, wherein the base substrate is comprised of polyimide, polyethylene terephthalate, polyester, polyurethane, polycarbonate, or a combination thereof.

22. The flexible device of claim 12, wherein the buffer layer includes at least one of silk, cotton, microfiber, nylon, polyester, hemp, and bamboo.

23. The flexible device of claim 12, wherein the chip or integrated circuit is mounted to the first surface of the base substrate.

24. The flexible device of claim 12, wherein the chip or integrated circuit is mounted to the second surface of the base substrate.
